(19) United States
(12) Patent Application Publication
(10) Pub. No.: US 2026/0193530 A1
(43) Pub. Date: Jul. 9, 2026

(54) COMPOSITION AND METH ODS FOR INHIBITING CORROSION OF METAL DURING ACIDIZING A WELLBORE IN A SUBTERRANEAN FORMATION FOR FRACKING

(71) Applicant: Roy W Martin, Naples, FL (US)

(72) Inventor: Roy W Martin, Naples, FL (US)

(21) Appl. No.: 19/208,667

(22) Filed: May 15, 2025

Related U.S. Application Data
(63) Continuation-in-part of application No. 19/170,589, filed on Apr. 4, 2025, now Pat. No. 12,473,800.
(60) Provisional application No. 63/742,905, filed on Jan. 8, 2025.
(60) Provisional application No. 63/771,796, filed on Mar. 14, 2025.
(60) Provisional application No. 63/773,577, filed on Mar. 18, 2025.

(51) Int. Cl. C09K 8/74; C09K 8/54; C09K 8/60; E21B 37/06; E21B 43/11; E21B 43/27

(52) U.S. Cl. CPC C09K 8/74; C09K 8/54; C09K 8/602; E21B 37/06; E21B 43/11; E21B 43/27; C09K 2208/32

(57) ABSTRACT

Compositions and methods for inhibiting corrosion of metal in a wellbore during acidizing a wellbore in a subterranean formation. The composition comprising novel oxidative coupling products and methods for their synthesis and application.

### FIELD OF THE INVENTION

The invention relates to compositions and methods for inhibiting corrosion of at least metal in a wellbore during acidizing a wellbore in a subterranean formation for fracking and extraction of oil. The metal can be for example a casing of the wellbore, a wireline, or a perforation tool.

### BACKGROUND OF THE INVENTION

Corrosion of metal surfaces of the casing of the wellbore, the wireline, or the perforation tool used for fracking caused by acids during acidizing of the wellbore are common problems. Furthermore, it is common practice to remove the perforation tool from the wellbore prior to acidizing of the wellbore to prevent corrosion of the metal surface of the perforation tool.

U.S. Patent Publication No. 20240279533 (McLoughlin) discloses compositions used to reduce corrosion of a casing of the wellbore, a wireline, or a perforation tool in the wellbore caused by acids during acidizing of the wellbore. The perforation tool can remain in the wellbore during the acidizing of the wellbore. The complete disclosure of this publication is incorporated herein by reference.

U.S. application No. 20140116708A1 discloses a water-in-oil emulsion comprising from 50:50 to 80:20 v/v water phase to oil phase. The disclosure further recites addition of corrosion inhibitors including quaternary compounds, cinnamaldehyde, acetylenic alcohols, intensifiers, cuprous ions, and carboxylic acids (i.e. formic acid).

U.S. Pat. No. 10,822,535 discloses a synthetic acid comprising hydrochloric acid and monoethanol amine at a molar ratio of 15:1 to 3:1 respectively with the preferred molar ratio of 4.1:1 respectively. FIG. 1 of the said patent illustrates the dissolution rate of Indiana limestone comparing the preferred embodiment to 15% hydrochloric acid.

### SUMMARY OF THE INVENTION

Quaternary surfactants exemplified by quaternary pyridinium and quaternary quinolinium are desirable corrosion inhibitors for acidizing compositions. Because the metal (i.e. carbon steel) surface in acid solutions are etched of oxide films, the surfaces take on a cationic charge due to the presence of iron. While chloride anions in hydrochloric acid impart a bridging anionic charge between the corrosion inhibitor and the steel surface, intensifiers are typically applied to transition the surface to an anionic charge thereby making it suitable for adsorption of the quaternary surfactant. Examples of commonly used intensifiers include: iodide, iodate, bromide, formaldehyde, acetaldehyde, formic acid, antimony, stannous, bismuth and germanium. One preferred intensifier is glyoxal at about 200 to 2000 ppm glyoxal. Furthermore, combining glyoxal with iodide provides a synergistic effect.

Halide “Intensifiers” like bromide and iodide further increase the attraction of the quaternary corrosion inhibitor Cl<Br<I with iodide ions possessing higher atomic mass and lower electronegativity than bromide or chloride.

The addition of halides enhances the adsorption of the quaternary corrosion inhibitor. However, the halides function as a mediary between the metal (steel) surfaces and quaternary corrosion inhibitor. This relationship can be represented as Quat-Halide-Fe interactions with the halide being the mediary (bridging ion) that ties them together.

Furthermore, imperfections (interruptions) in coverage of the steel substrate resulting from the geometry of the quaternary hydrophobic structure expose the surface to the corrosive acid solution resulting in: corrosion, dissolution of iron ions and evolution of hydrogen gas. To combat the persistent deterioration and subsequent loss of integrity of the protective film, a residual (reservoir) of corrosion inhibitor is needed to reestablish the film.

In order to mitigate the inherent weaknesses and subsequent metal losses resulting from these limitations, a new novel corrosion inhibitor chemistry is required.

This novel invention improves corrosion inhibition of metal (steel) during acidizing of the wellbore increasing the life of the wireline and perforating gun, thereby allowing increased perforating cycles of said equipment.

The novel corrosion inhibitors are oxidative coupling product comprising at least one quaternized pyridinium-quinolinium complex, quaternized pyridinium-pyridinium complex and quaternized quinolinium-quinolinium complex. The resulting oxidative coupling product (OCP) demonstrates dramatic reductions in corrosion inhibition of steel in acid solution and elevated temperatures compared to comparable concentrations of the quaternized starting compounds (e.g. quaternary pyridinium, quaternary quinolinium) and their combinations.

Disclosed are novel compositions and methods for inhibiting corrosion of metal in a wellbore during acidizing a wellbore in a subterranean formation for fracking and extraction of oil and gas. The disclosed compositions exhibit unexpected and surprisingly superior corrosion inhibition of metal surfaces compared to the prior art corrosion inhibitor compositions and methods. Application of the disclosed invention provides surprising and unexpectedly significant economic and performance advantages over the prior art.

### Objectives

In the first objective, the methods and compositions of the present invention mitigate the imperfections in the coverage of the metal substrate by bridging the gaps created by the geometry of the quaternary hydrophobic structure of the adsorbed corrosion inhibitor thereby forming a more uniform hydrophobic barrier film that impedes the aqueous phase from reaching the metal surface and inducing corrosion. This objective can be accomplished by: 1) establishing a uniform anionic charge across the surface of the metal substrate, and forming a more tenacious oxide surface across the metal substrate; and 2) forming a uniform hydrophobic barrier film that mitigates the gaps resulting from the geometry of the hydrophobic tail of the quaternary corrosion inhibitor.

Establishing a uniform anionic charge across the surface of the metal substrate is accomplished by applying intensifiers that adsorb onto the cationic charge iron (Fe) on the metal surface. Some intensifiers react with the iron in the steel resulting in the formation of an iron-oxide surface, while other intensifiers exemplified by iodide (iodate) and bromide form anionic charged bridges between the cationic iron on the metal surface and the quaternary corrosion inhibitor further mitigating gaps and increasing the surface area of the hydrophobic barrier film. Combining intensifiers that form iron-oxide complexes and anionic bridges provides a synergistic effect, thereby enhancing the hydrophobic coverage of the steel resulting from the adsorption of the quaternary corrosion inhibitors.

The OCPs disclosed impart a larger surface area of hydrophobic backbone compared to the building blocks of the OCPs. Without being bound by theory, it is believed the aromatic (and in some cases alkyl) structure of the OCPs mitigate the gaps between the geometry of the hydrophobic tails when using the quaternary building blocks of OCPs. Furthermore, the resilience of the protective film is significantly higher than that formed by the quaternary aromatic corrosion inhibitors used to synthesize the OCP oligomers and co-oligomers.

The OCPs comprise oligomers and/or co-oligomers of the quaternary aromatic corrosion inhibitors used to produce them. The number of carbon-carbon bonds (C—C) that link the quaternary aromatic corrosion inhibitors (precursors) can be controlled by regulating the molar ratio of nitrite to precursor as well as controlling the rate of nitrous acid production. For example, higher molar ratios of nitrite will support more coupling resulting in higher molecular weight OCPs. Furthermore, applying acid such as hydrochloric acid quickly induces localized high concentrations of nitrous acid, which in turn induces rapid coupling of the quaternary aromatic corrosion inhibitors as illustrated by the rapid, almost instantaneous color transition disclosed in some of the examples. It is presumed that these variables can expectedly influence the performance of the OCPs produced. Therefore, optimization of synthesis methods can be conducted to produce the desired performance of the OCPs with respect to corrosion inhibition.

### Embodiments

In the first embodiment is disclosed a composition for acidizing a wellbore, the composition comprising:
at least one mineral acid, an effective amount of oxidative coupling product, a surfactant and at least one intensifier;
the mineral acid comprises at least hydrochloric acid in an amount ranging from about 10 to 20 wt % HCl, and
wherein the oxidative coupling product comprises at least one of an oligomer and co-oligomer resulting from an oxidative coupling reaction between at least one of quaternary quinolinium and quaternary pyridinium.

The composition in accordance with the first embodiment, wherein the mineral acid comprises about 15 wt % HCl.

The composition in accordance with the first embodiment, wherein the intensifier comprises an iodide donor.

The composition in accordance with the first embodiment, wherein the oxidative coupling product ranges from about 1000 to 10000 ppm as active oxidative coupling product.

The composition in accordance with the first embodiment, wherein the composition is diluted with water at the point-of-use to achieve a ratio of composition and water of 1:1 respectively.

The composition in accordance with the first embodiment, wherein the composition is diluted with water at the point-of-use to achieve a ratio of composition and water of 1:2 respectively.

The composition in accordance with the first embodiment, wherein the surfactant comprises a nonionic surfactant.

The composition in accordance with the first embodiment, wherein the surfactant comprises an anionic surfactant.

The composition in accordance with the first embodiment, wherein the anionic surfactant is selected from at least one of an alkyl ether sulfates, alkyl sulfates, alkyl sulfonates, alkyl benzene sulfonates, alkyldiphenyloxide disulfonate and phosphate ester.

The composition in accordance with the first embodiment, wherein the intensifier comprises at least one of a formaldehyde, acetaldehyde, formic acid, antimony, stannous, bismuth, germanium and dialdehyde.

The composition in accordance with the first embodiment, wherein the dialdehyde comprises glyoxal.

The composition in accordance with the first embodiment, further comprising addition of an aliphatic oil.

The method in accordance with the first embodiment, wherein the oxidative coupling product is the result of:
combining and mixing in a vessel a solvent, at least one quaternary aromatic corrosion inhibitor selected from at least one of quaternary pyridinium and quaternary quinolinium, a nitrite donor and an acid;
the solvent comprises at least one of a glycol ether, alcohol and water;
the nitrite donor in an amount to provide greater than or equal to 0.2 mole of nitrite per mole of quaternary aromatic corrosion inhibitor;
the acid in an amount sufficient to in-situ generate an effective amount of nitrous acid;
the nitrous acid initiates an oxidative coupling reaction producing the oxidative coupling product, and
wherein the oxidative coupling product comprises two or more carbon-carbon bonded quaternary aromatic corrosion inhibitors.

The composition in accordance with the first embodiment, further comprising a quaternary aromatic phosphonium selected from at least one of benzyltriphenylphosphonium salts and tetraphenylphosphonium salts.

The method in accordance with the first embodiment wherein the intensifier comprises at least one of an iodide donor, a bromide donor, formaldehyde, formic acid, an antimony donor, a bismuth donor, a germanium donor, a stannous donor and dialdehydes.

Non-limiting examples of dialdehydes include glyoxal, glutaraldehyde, phthalaldehyde and succinaldehyde.

In the second embodiment is disclosed:

a method of forming a hydrocarbon-bearing formation for a stimulation operation, the method comprising the steps:

providing a wellbore having a casing;
assessing at least a first location and a second location for perforation of the casing;
inserting a bottom hole assembly into the well-bore;
the bottom hole assembly comprising a plug and a perforation tool and the bottom hole assembly being connected to a wireline;
injecting an acidic composition into the wellbore;
wherein the acidic composition is in direct contact with the perforation tool, the wireline and the casing;
positioning and setting the plug in the wellbore at a position downhole but proximate to the first location;
positioning the perforation tool at the first location;
perforating the casing at the first location with the perforation tool thereby creating a first perforated area and a first cementitious debris;
allowing the acidic composition to come into contact with the first perforated area and the first cementitious debris for a predetermined period of time to prepare the formation for the stimulation operation;
moving the perforation tool up-hole to the second location;
perforating the casing at the second location with the perforation tool thereby creating a second perforated area and a second cementitious debris;
allowing the acidic composition to come into contact with the second perforated area and the second cementitious debris for a predetermined period of time to prepare the formation for the stimulation operation;
removing the perforation tool from the wellbore;
wherein the acid composition comprises an acid and a corrosion inhibitor composition, the corrosion inhibitor composition comprising:
an effective amount of corrosion inhibiting oxidative coupling product, at least one anionic surfactant and at least one intensifier;
the oxidative coupling product comprises at least one of an oligomer and co-oligomer resulting from an oxidative coupling reaction between at least one of quaternary quinolinium and quaternary pyridinium, and
wherein the intensifier comprising at least one of an iodide donor and dialdehyde.

The corrosion inhibitor composition in accordance with the second embodiment, wherein the anionic surfactant comprises at least one of an alkyl sulfate, alkyl ether sulfate, alkyl aryl sulfonate, alkyl diphenyl oxide disulfonate and phosphate ester.

The composition in accordance with the second embodiment, further comprising addition of an aliphatic oil.

The corrosion inhibiting composition in accordance with the second embodiment, wherein the oxidative coupling product ranges from about 1000 to 10000 ppm as active oxidative coupling product.

The composition in accordance with the second embodiment, wherein the dialdehyde comprises glyoxal.

The acid composition in accordance with the second embodiment, wherein the composition is diluted with water at the point-of-use to achieve a ratio of composition and water of 1:1 respectively.

The acid composition in accordance with the second embodiment, wherein the composition is diluted with water at the point-of-use to achieve a ratio of composition and water of 1:2 respectively.

The method in accordance with the second embodiment, wherein the oxidative coupling product is the result of:
combining and mixing in a vessel a solvent, at least one quaternary aromatic corrosion inhibitor selected from at least one of quaternary pyridinium and quaternary quinolinium, a nitrite donor and an acid;
the solvent comprises at least one of a glycol ether, alcohol and water;
the nitrite donor in an amount to provide greater than or equal to 0.2 mole of nitrite per mole of quaternary aromatic corrosion inhibitor;
the acid in an amount sufficient to in-situ generate an effective amount of nitrous acid; the nitrous acid initiates an oxidative coupling reaction producing the oxidative coupling product, and
wherein the oxidative coupling product comprises two or more carbon-carbon bonded quaternary aromatic corrosion inhibitors.

### BRIEF DESCRIPTION OF FIGURES

FIG. 1 illustrates non-limiting examples of suitable quaternary aromatic corrosion inhibitors suitable for producing oxidative coupling products disclosed in the invention.

FIG. 2 illustrates the change in depth of color after acid addition showing the effect resulting from the in-situ generated nitrous acid activation of the oxidative coupling product reaction.

FIG. 3 illustrates the theoretical reaction mechanism for the oxidative coupling reaction. The aromatic groups like those inherent to the quaternary aromatic corrosion inhibitors disclosed couple through a single carbon-carbon (C—C) bond.

FIG. 4. illustrates the theoretical general structure of an oxidative coupling product produced by reacting a quaternary quinolinium compound using the oxidative coupling reaction initiated using nitrous acid. The example shows more than two quaternary aromatic corrosion inhibitor molecules can be linked resulting in a higher molecular weight OCP.

FIG. 5 illustrates the theoretical general structure of an oxidative coupling product produced by reacting a quaternary quinolinium along with quaternary pyridinium using the oxidative coupling reaction initiated using nitrous acid. The example shows more than two quaternary aromatic corrosion inhibitor molecules can be linked resulting in a higher molecular weight OCP.

FIG. 6 illustrates a 1010 carbon steel coupon after exposure to SYN #9 and Alpha 1038 at about 94-95° C. for 4 hours. After thoroughly immersing and swirling in water, followed by immersing and swirling in acetone, the SYN #9 coupon retained a uniform adherent tan/brown film, while the Alpha 1038 treated coupon acquired a grey metallic appearance. The SYN #9 observation was extremely uncharacteristic compared to the other coupons treated with Alpha 1038, Uniquat 10-80 and their blends. Adsorbed films using commercially available treatments often appear to have blotches of oily residue that readily dissolves in acetone. In the SYN #9 example, the hydrophobic film appeared extremely uniform on both sides of the coupon and was extremely persistent even after exposure to the acetone.

FIG. 7 illustrates the rate of acid digestion of Indiana limestone by various acidizing compositions compared to a 15% HCl as the Control. The weight loss resulting from the release of carbon dioxide is accumulated over 1-minute increments. Preferred acidizing compositions of the present invention were compared to HCR-7000 which is the preferred acidizing composition in the reference prior art. The results illustrate the improved retarding effects of the present invention without the addition of weak bases exemplified by monoethanolamine, lysine, glycine urea and the like.

FIG. 8 illustrates examples of preferred quaternary phosphonium compounds suitable for use as corrosion inhibitors.

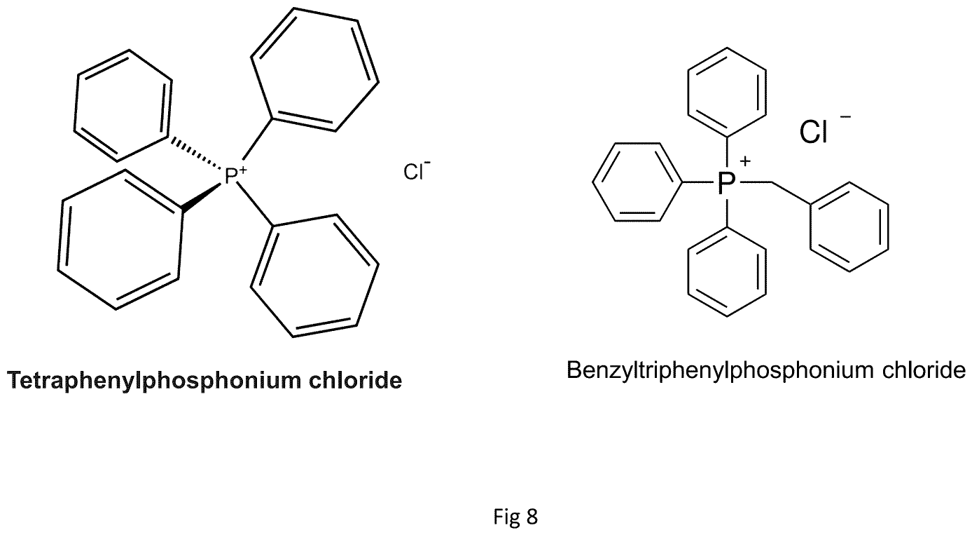

### DETAILED DESCRIPTION OF THE INVENTION

The following terms will be used throughout the specification and will have the following meanings unless otherwise indicated.

“A” or “an” means “at least one” or “one or more” unless otherwise indicated.

“Comprise”, “have”, “include” and “contain” (and their variants) are open-ended linking verbs and allow the addition of other elements when used in a claim. “Consisting of” is closed, and excludes all additional elements.

“Consisting essentially of” excludes additional material elements, but allows the inclusions of non-material elements that do not substantially change the nature of the invention.

When referring to a group, “at least one . . . and . . . ” in the specification and claims is synonymous with “and/or”. For example, “at least one of A, B and C” means A alone, B alone, C alone, or any combination of A, B or C.

“wt. %” is based on the total weight of the composition unless otherwise stated.

### Definitions

Various compositions and methods of the invention are described below. Although particular compositions and methods are exemplified herein, it is understood that any of a number of alternative compositions and methods are applicable and suitable for use in practicing the invention.

As used herein, “ambient temperature” is used to describe the ability to carry out the oxidative coupling reaction without applying heat energy to elevate the temperature. Ambient temperature comprising typical room temperature (68-76° F.) allows the reaction to proceed. Reference to ambient temperature is not used to limit the range of temperature, it is only used to highlight the ability to carry out the oxidative coupling reaction without applying heat.

As used herein, “wellbore” describes the drilled channel (hole) within a subterranean formation that is lined with a metal casing (pipe).

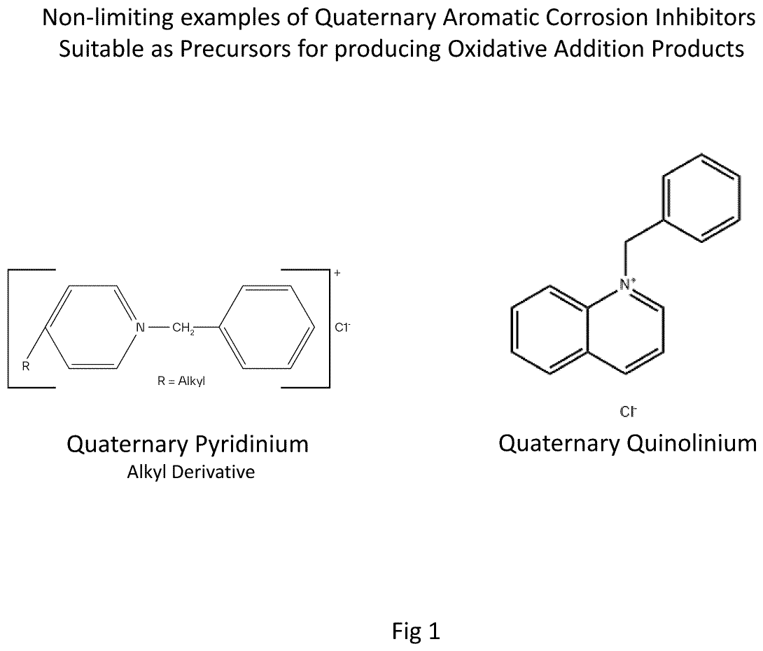

As used herein, “oxidative coupling product” also referred to as “OCP” and/or “OCPs” describes the product produced from an oxidative coupling reaction that results in a condensation product between two or more molecules of quaternary corrosion inhibitors selected from at least one of quaternary pyridinium and quaternary quinolinium and their various combinations (molar or wt % ratios). The said pyridinium and quinolinium may further comprise alkyl and/or aryl derivatives as illustrated in FIG. 1. The oxidative coupling product comprises at least one quaternary function group but preferably comprise two or more quaternary functional groups. Furthermore, when higher molar ratios of nitrite donor are applied during the production of OCPs, additional linking between the reactants occur resulting in an OCP comprising more than two bonded (linked) oxidative coupling reactants. For example, an OCP comprising a quaternary pyridinium-quinolinium complex may undergo additional oxidative coupling to produce a quaternary pyridinium-quinolinium-pyridinium complex. These higher molecular weight OCPs can form a tar like precipitate that is readily dissolved in an appropriate solvent system such as glycol ethers.

As used herein, “quaternary pyridinium-pyridinium” describes the general family of the OCP resulting from the oxidative coupling reaction. Use of the description quaternary pyridinium-pyridinium does not limit the molecular structure to two linked pyridinium molecules, neither does it limit the quaternary functionality to one quaternary group. In fact, the resulting OCP product may comprise multiple molecules having two or more carbon-carbon bonded (oligomer) quaternary aromatic corrosion inhibitors thereby containing three or more pyridinium molecules and multiple quaternary functional groups.

As used herein, “quaternary pyridinium-quinolinium” describes the general family of the OCP resulting from the oxidative coupling reaction. Use of the description quaternary pyridinium-quinolinium does not limit the molecular structure to one quinolinium molecule linked to a pyridinium molecule. In fact, the resulting OCP product may comprise multiple molecules having two or more carbon-carbon bonded (co-oligomer) quaternary aromatic corrosion inhibitors thereby containing three or more pyridinium and/or quinolinium molecules and multiple quaternary functional groups.

As used herein, “quaternary quinolinium-quinolinium” describes the general family of the OCP resulting from the oxidative coupling reaction. Use of the description quaternary quinolinium-quinolinium does not limit the molecular structure to two linked quinolinium molecules. In fact, the resulting OCP product may comprise multiple molecules having two or more carbon-carbon bonded (oligomer) quaternary aromatic corrosion inhibitors thereby containing three or more pyridinium molecules and multiple quaternary functional groups.

As used herein, “oxidative coupling reaction” describes the mechanism that chemically bonds (couples) two or more molecules of quaternary aromatic corrosion inhibitors selected from at least one of quaternary quinolinium and quaternary pyridinium resulting in the production of a corrosion inhibiting oxidative coupling product comprising at least one of an oligomer and co-oligomer or said quaternary aromatic corrosion inhibitors. Without being bound by theory, the oxidative coupling product is believed to be the condensation product of the quaternary corrosion inhibitors resulting from oxidative coupling initiated by the decomposition products of nitrous acid exemplified by free radical nitric oxide (NO⋅), nitrosonium (NO⁺) and the like.

As used herein, “nitrous acid initiates an oxidative coupling reaction” describes the use of in-situ generated nitrous acid to initiate the oxidative coupling reaction. Without being bound by theory, it is believed at least one of nitrous acid and/or the decomposition products of nitrous acid exemplified by nitric oxide (NO⋅), nitrosonium (NO⁺) initiate the coupling reaction resulting in a condensation product comprising a higher molecular weight quaternary oxidative coupling product.

As used herein “based on active OCP” refers to the amount of oxidative coupling product in the formulation used as a corrosion inhibitor. For example, if the formulated product comprises 20 wt % OCPs, to achieve 1000 ppm based on active OCP, the amount of the formulated product added to the acidizing solution would be 5000 ppm formulated product.

As used herein “acid composition” and “acidizing composition” can be used interchangeably.

As used herein, “metal” is used to describe carbon steel, carbon steel alloys and stainless steel that comes in contact with the aqueous acidizing composition during the acidizing of the wellbore in fracking operation. Examples of such metallic surfaces include the steel casing lining the wellbore, the wireline and the perforating gun.

As used herein, “gpt” means gallons per thousand, and specifically pertains to the dosage of corrosion inhibiting composition (gallons) added per 1000 gallons of aqueous acidizing composition.

As used herein, “iodide donor” describes a compound that comprises an iodide atom. Non-limiting examples of iodide donors include: sodium iodide, potassium iodide, ammonium iodide, cupper iodide, iodine and iodate salts.

As used herein, “bromide donor” describes at source of bromide exemplified by the non-limiting examples: sodium bromide, potassium bromide, lithium bromide, ammonium bromide and the like.

As used herein, “phosphate donor” describes a source of phosphate exemplified by the non-limiting examples: diammonium hydrogen phosphate, disodium phosphate, monosodium phosphate and phosphoric acid.

As used herein, “effective amount” describes the concentration of a chemical to achieve the target effect. Non-limiting examples include: an effective amount of nitrous acid is the concentration required to produce the target amount of oxidative coupling product; an effective amount of oxidative coupling product is the concentration required to provide a corrosion rate of steel below that achieved by using a higher concentration of quaternary precursors used to produce the (OCP). To further clarify, assume a 1:1 wt % blend of quaternary pyridinium and quaternary quinolinium applied at 2 wt % based on the acidizing solution provides a metal loss of 0.05 lbm/ft² at 200° F. with 6 hr exposure. An effective amount of OCP will be a concentration of <2 wt % while achieving ≤0.05 lbm/ft² at 200° F. with 6 hr exposure.

As used herein, “oligomer” described two or more quaternary aromatic corrosion inhibitors comprising the same molecule coupled together by a carbon-carbon (C—C) bond. The quaternary aromatic corrosion inhibitor comprises a quaternary quinolinium or a quaternary pyridinium so that the oxidative coupling product has two or more quaternary quinolinium molecules coupled (bonded) together or two or more quaternary pyridinium molecules coupled (bonded).

As used herein, “co-oligomer” described two or more quaternary aromatic corrosion inhibitors comprising two different molecules of quaternary corrosion inhibitors coupled together by a carbon-carbon (C—C) bond. The quaternary aromatic corrosion inhibitor comprises a quaternary quinolinium-pyridinium complex. When producing co-oligomers, it is expected there will also be oligomers produced. Disclosing compositions and methods comprising co-oligomers is not meant to preclude the absence of oligomers.

As used herein “derivatives” as it pertains to “oligomer” and “co-oligomer” describes variations in the structure of the oxidation coupling product as a result of the presence of residuals or additives having cyclic structures that couple with the oligomers and co-oligomers. For example, residual quinolinium resulting from the production of quaternary quinolinium can couple with quaternary quinolinium during the oxidative coupling reactions thereby resulting in a derivative of the oligomer quaternary quinolinium-quinolinium complex.

As used herein, “quaternary aromatic phosphonium” comprises a quaternary phosphonium having at least one aromatic group exemplified by the non-limiting examples benzyl and phenyl. Preferably there are two or more aromatic groups comprising the quaternary aromatic phosphonium compound. Non-limiting examples of preferred quaternary aromatic phosphonium compounds include tetraphenyl phosphonium salts and benzyl triphenyl phosphonium salts.

As used herein, “point-of-use” describes the location at which the acidizing composition is applied to the wellbore. The point-of-use is the location where the concentrated composition for acidizing a wellbore is diluted with water at a ratio from about 1:1 to 1:2 acidizing composition to water respectively thereby reducing the freight, storage and chemical cost of acidizing the wellbore.

As used herein, “water” having the chemical formula H₂O may comprise various concentrations of mineral salts (e.g. brine, produced water) and other additives and contaminants that are dissolved or dispersed in the water resulting in an aqueous solution.

### Acids

Examples of the acid concentration in the aqueous acidizing composition range between about 5 to 28 wt %, more preferably about 7.5 to 20 wt % and most preferably about 10 to 15 wt %. Suitable acid can be selected from mineral acids, organic acids and/or any combination thereof. Non-limiting examples of mineral acids include hydrochloric acid, sulfuric acid, hydrofluoric acid and the like. Non-limiting examples of organic acids include formic acid, acetic acid, citric acid and the like.

Acids may further comprise synthetic acids stabilized using retarding agents.

Retarding agents are organic nitrogen bearing compounds that form adducts with the acid to slow the release of the hydrogen and retard the aggressive corrosive nature of the acid. For example, urea combined with hydrochloric acid forms urea hydrochloride which dramatically retards the reactivity of the acid solution and suppresses the toxic vapors. Numerous retarding agents have been disclosed in the prior art including amino acids (e.g. glycine, lysine etc.), amino alcohols (e.g. monoethanolamine, diethanolamine etc.) and amines such as morpholine and dieethylhydroxlamine. These are non-limiting examples and the limited examples is not intended to limit the viable retarding agents available. Prior art can be referenced for a more comprehensive list of available retarding agents.

Preferred retarding agents are thermally stable nitrogen bearing compounds that can handle greater than 150° C. in and aqueous solution without undergoing thermal decomposition. Non-limiting examples of thermally stable nitrogen bearing compounds include glycine, aspartate, asparagine, cysteine, glutamate, glutamine, arginine, histidine and hydrazine. The thermally stable nitrogen bearing compounds can be combined with hydrochloric acid to produce adducts that reduce the aggressive corrosion of the hydrochloric acid thereby extending the life of the synthetic acid when applied to the wellbore and reducing the potential damage to the formation near the wellbore. Limestone testing demonstrates the dramatic reduction in the dissolution of limestone especially when the synthetic acid is combined with the OCPs disclosed.

The molar ratio of thermally stable nitrogen bearing compounds to hydrochloric acid range from 1:8 to 1:1, more preferred 1:6 to 1:1.5 and most preferred 1:4 to 1:2 respectively.

Surfactants can be nonionic, anionic and amphoteric.

Nonionic surfactants are preferably ethoxylated alcohols.

Anionic surfactants are selected from at least one of an alkyl ether sulfates, alkyl sulfates, alkyl sulfonates, alkyl benzene sulfonates, alkyldiphenyloxide disulfonate and phosphate esters. Phosphate esters preferably have greater than or equal to 3 moles of ethylene oxide (EO), more preferred greater than or equal to 6 moles of EO and most preferred greater than or equal to 9 moles of EO.

Quaternary quinolinium based corrosion inhibitor dissolved in solvent exemplified by alcohols, glycol ethers and the like form homogenous solutions. However, the quaternary quinolinium corrosion inhibitors comprise tar residuals that are insoluble when diluted in aqueous solution such as hydrochloric acid. This insoluble material forms sticky tar-like agglomerates that adhere to equipment such as vessels used to produce the acidizing solutions, vessels used to transport and store the acidizing solution. Furthermore, this residue can form black tar-like deposits on the steel being treated to inhibit the corrosion.

It has been discovered addition of an effective amount of an aliphatic oil such as paraffin oil into the OCP product effectively disperses the tar residues that form when the OCP product is added to an aqueous solution. The precipitate that does form when the OCP product is added to form the acidizing treatment is in the form of a free-flowing powder-like substance that is easily dispersed with mixing etc.

An effective amount of aliphatic oil may comprise about 0.2 wt % to about 10 wt % based on the weight percent of the starting quaternary quinolinium corrosion inhibitor used to produce the OCP product. Non-limiting examples of commercially available aliphatic oil include Escaid 110, Escaid 120 and Escaid 120ULA sold by ExxonMobil.

### Synthesis of Oxidative Coupling Product

The methods of synthesis being disclosed are not meant to limit the invention in any way. They are non-limiting examples to illustrate a pathway toward the viable production and commercialization of the OCPs.

OCPs originate from the reaction of either pyridinium and/or quinolinium with benzyl chloride. The resulting quaternary pyridinium and quaternary quinolinium are then reacted using oxidative coupling reaction to produce the oxidative coupling product. Other heterocyclic precursors exemplified by imidazoline may be suitable as well.

A novel method is disclosed that utilizes acid (H⁺ donor) activated nitrite to form nitrous acid. Nitrous acid is a weak acid having a reported pKa value of about 3.3. As a weak acid there is an equilibrium established between the protonated nitrous acid and the unprotonated nitrite where a 1:1 ratio of protonated to unprotonated occurs at about a pH of 3.3. The acid used to activate the nitrite to nitrous acid can be a mineral acid or organic acids. Non-limiting examples of acids include: hydrochloric acid, sulfuric acid, phosphoric acid, methanesulfonic acid and formic acid.

When the pH of the solution is lowered to <6, the oxidative coupling reaction is observed over time but at a relatively slow rate. As more acid is added and the pH is further lowered, nitrous acid concentrations increase and the rate of the oxidative coupling reaction increases. When the pH is reduced to below the pKa of HNO₂ (~3.3) value, the rate of oxidative coupling is accelerated dramatically. As illustrated in the synthesis examples, when the pH was lowered to below the pKa value the rate of change in color and depth of color (darkness) of the reacting solution was almost instantaneous. The transition from a brown solution to a red-black solution occurred over a period of seconds. Therefore, the speed of the synthesis can be controlled by adjusting the addition of acid to increase the conversion of nitrite to nitrous acid and its various decomposition products that drive the oxidative coupling reaction. Furthermore, implementing process control to automatically feed the acid to target a pH would be a viable means of minimizing production time and may allow for a continuous production process as opposed to a batch process.

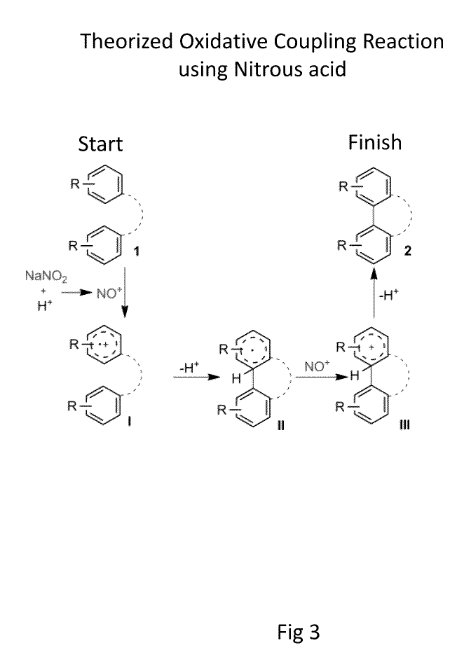

The amount of nitrite donor is preferably greater than or equal to 0.2 mole, more preferred greater than or equal to 0.5 mole and most preferred greater than or equal to 1 mole nitrite donor per mole of quaternary corrosion inhibitor (QCI). The oxidative coupling reaction only requires one of the two QCI molecules to be oxidized to initiate the linkage between the two QCI molecules as illustrated in FIG. 3. Theoretically, oxidizing 50% of the QCI molecules is sufficient to produce 100% of the targeted oxidative coupling product. However, the ability to control which molecules are oxidized and which one are not is not obtainable. Excess oxidation can induce coupling of multiple QCI molecules leading to the formation of a tar like precipitate. Additional solvent and/or selection of more suitable solvent such as glycol ether readily dissolves the higher molecular weight OCP as illustrated in the examples. A nitrite donor molar ratio of about 0.2 to 4 per mole of QCI is a suitable range for synthesis of the OCP using the method disclosed, but this proposed range is not meant to be a limiting factor.

The quaternary pyridinium and quaternary quinolinium can be produced independently then mixed and matched as desired, or can be produced together in a single pot by combining pyridinium and quinolinium in the desired ratios, then reacting with benzyl halide (e.g. chloride or bromide).

Another option is to purchase at least one of a commercially available quaternary pyridinium and/or quaternary quinolinium, then mix and match as desired to produce the OCP.

For illustration, if quaternary pyridinium is purchased, it can be added to the solvent (i.e. glycol ether-water) followed by addition of the nitrite donor (NaNO₂, KNO₂ etc.) and reacted thereby simplifying the production process.

The ratio of quaternary pyridinium and quaternary quinolinium can be varied to achieve the desired blend of OCPs. For example, a 1:1 molar ratio of quaternary pyridinium to quaternary quinolinium would be expected to result in blend of quaternary pyridinium-quinolinium, quaternary pyridinium-pyridinium and quaternary quinolinium-quinolinium complexes. Altering the molar ratio to 0.5:1 would result in a different mixture of OCPs. However the actual OCP resulting from the mixture will also depend on the number of carbon-carbon linkages that occur which can be controlled to some extent by the molar ratio of nitrite donor.

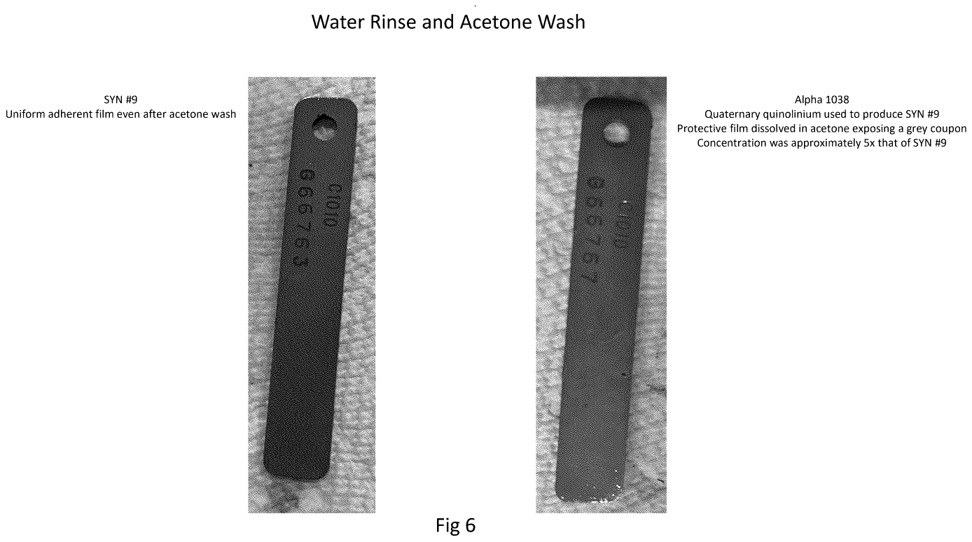

One preferred OCP comprises a mixture of oxidative coupling products resulting from the combining quaternary aromatic corrosion inhibitors selected from at least one of quaternary pyridinium and quaternary quinolinium. Combining quaternary pyridinium and quaternary quinolinium with a solvent results in a mixture to produce the oxidative coupling products resulting in a mixture of oxidative coupling products comprising: quaternary pyridinium-pyridinium, quaternary pyridinium-quinolinium and quaternary quinolinium-quinolinium. Without being bound by theory, a mixture of oxidative coupling products synergistically works by allowing different geometric structures to mix and match to inhibit voids and enhance the coverage of the metal by the hydrophobic film resulting from the adsorbed OCPs, much like the pieces of a puzzle having different shapes and sizes fill the voids of the puzzle. The resulting hydrophobic film (FIG. 6) is very uniform and resistant to even solvents such as acetone that otherwise will readily dissolve the protective film resulting from the quaternary corrosion inhibitors (QCI) used to produce the oxidative coupling product. Addition of residual quaternary pyridinium and quaternary quinolinium may further enhance the performance of the oxidative coupling products by providing lower molecular weight quaternary corrosion inhibitors to enhance the hydrophobic coverage.

Solvents for producing and formulating compositions comprising CAPs may include non-limiting examples: alcohols, water, acetone, ethylene glycol monobutyl ether, glycols, glycol ethers, DMSO and the like. Preferred solvents comprise mixtures exemplified by glycol ether, alcohol and water.

The nitrite donor can comprise any source of nitrite exemplified by the non-limiting examples sodium nitrite, potassium nitrite, lithium nitrite and the like. The amount of nitrite to produce the oxidative coupling product is greater than or equal to 0.2 mole per mole of quaternary pyridinium and/or quaternary quinolinium reactants use to produce the OCPs. Preferably the amount of nitrite donor is greater than or equal to 0.5 mole and more preferred greater than or equal to 1 mole per mole of quaternary corrosion inhibitor.

Acid addition is used to in-situ generate nitrous acid from the nitrite donor. Preferably only enough acid is added to acidify the OCP producing solution to provide and sustain an effective amount of nitrous acid to drive the oxidative coupling reaction in a controlled manner. Therefore, controlling the amount of nitrite donor and acidity (i.e. pH) are useful in optimizing the production of the targeted OCP. Without being bound by theory, higher molar ratios of nitrite donor may result in higher molecular weight OCPs by linking two or more quaternary aromatic corrosion inhibitors together. It is believed the resulting OCPs maintain their charge density by retaining the quaternary functionality on the original quaternary aromatic corrosion inhibitor. As disclosed, additional acid that causes the pH to approach or go below the pKa of nitrous acid accelerates the rate of the oxidative coupling reaction.

### Methods

The description that follows, and the embodiments described therein, is provided by way of illustration of an example, or examples, of particular embodiments of the principles of the present invention. These examples are provided for the purposes of explanation, and not limitation, of those principles and of the invention.

In a conventional plug and perforate operations, the isolation plug is set in the well, the casing is perforated by a tool (guns), then the tool is pulled out of the hole and then acid is pumped and circulated to the perforations (this process can take hours in some extreme cases) and once a feed rate is reached, they begin the stimulation for that stage of the well. The process is then repeated (over 40 to 100 or more stages in many cases).

According to a preferred embodiment of the present invention, the method allows for an operator to pump the tools down with the spearhead acid to perforate the zone and let the acid sit over the perforations or perforate in the acid. This is followed by the removal of the tool from the wellbore and initiating of the stimulation immediately following the perforating tools removal, thereby greatly increasing the efficiency of the operation by removing an entire step from the common process.

According to a preferred embodiment of the present invention, this method can save up to an one (1) hour per stage at an average cost of $20,000/hr (for the stimulation crew and equipment) and 30-50 m³ (8000-13,250 gallons) of water per stage depending on depth, casing size and final method. In an average 50-stage well, this can translate into savings of up to or over $1,000,000 in time plus the saved water of up to or over 800,000 gallons. The potential savings from the implementation of this method in operations in the North America alone could reach upwards of several hundreds of millions of dollars per year for the industry and billions of gallons of water saved.

Hydrochloric acid (HCl) is the most commonly used acid in stimulation or for spearhead acid. With this in mind, one must understand that perforation tools and the deployment wireline systems are mostly comprised of stainless metal to ensure longevity and offer the highest level or performance. Conventional plug and perforation processes require the removal of the perforation guns immediately after the perforation stage otherwise the spearhead acid could compromise the perforating guns and deployment wireline systems because of their propensity to attack stainless-metal and stainless-metal alloys. A critical factor in allowing a process to have stainless metal predominate components exposed to strong acids such as HCl is the ability to control or minimize corrosion to a level below which would normally render a stainless-metal tool and wireline deployment system unusable after only a few cycles (or even less in some cases). With the development of a novel corrosion inhibitor which affords substantial long-term acidic exposure protection of stainless metal or such acid sensitive alloys from damage from exposure to hydrochloric acid (HCl), there is a never-seen-before industrial or industry-widescale possibility of removing a time and water consuming step of the pre-stimulation process, thereby saving substantial time, money and water resources. The advantages are compounded when using optimal acidic compositions (i.e. effectiveness and corrosion inhibition) as more wells and more perforation operations can be carried out. The savings are compounded by the number of operations which are carried out without replacing the bottom hole assembly and/or the wireline/slickline or coiled tubing or applicable conveyance method. For this reason, a new generation of corrosion inhibitor for use during acidizing a wellbore is needed.

The compositions and methods disclosed provide superior corrosion inhibition and well as significantly improved economics when compared to the corrosion inhibitors disclosed in the prior art.

### SYNTHESIS EXAMPLES

### Example 1

Quaternary Pyridinium-Pyridinium Complex using in-situ generated nitrous acid.

A 500 ml round bottom reactor with magnetic stirring rod was secured on top of a magnetic stirrer. The following was added to the reactor while stirring:
100 ml Denatured Alcohol
100 ml R.O. Water
18.0 g KNO₂
20 ml Uniquat 10-80 (supplied by Arxada)

Once thoroughly mixed, 21.5 ml (~24.7 g) 31.25% HCl was slowly added while mixing. The temperature was continuously monitored and recorded shortly after the last of the acid was added (25° C.). It was noted that after approximately 10 ml of acid was added, the sample began boiling (gas generation) and the sample began darkening. With continued acid addition, the sample darkened more rapidly as was essentially black in color shortly after the last addition of acid.

### Example 2

Quaternary Pyridinium-Pyridinium Complex using in-situ generated nitrous acid.

A 500 ml round bottom reactor with magnetic stirring rod was secured on top of a magnetic stirrer. The following was added to the reactor while stirring:
100 ml Denatured Alcohol
100 ml R.O. Water
18.5 g KNO₂
20 ml Uniquat 10-80 (supplied by Arxada)

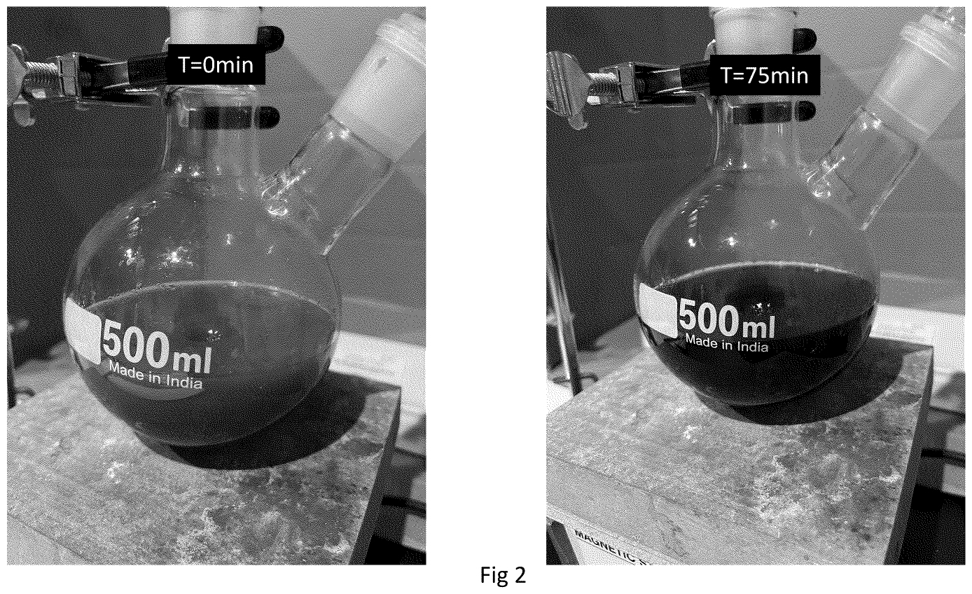

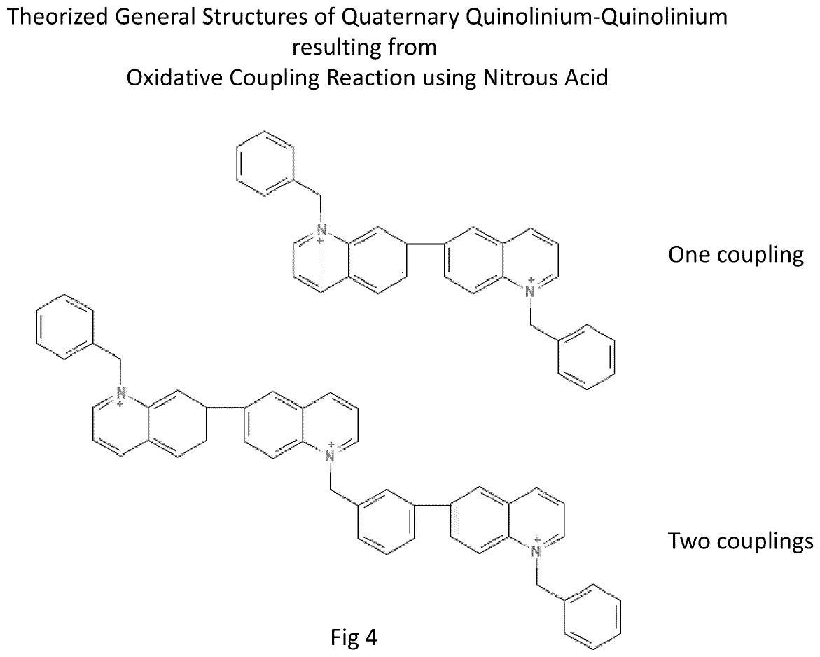

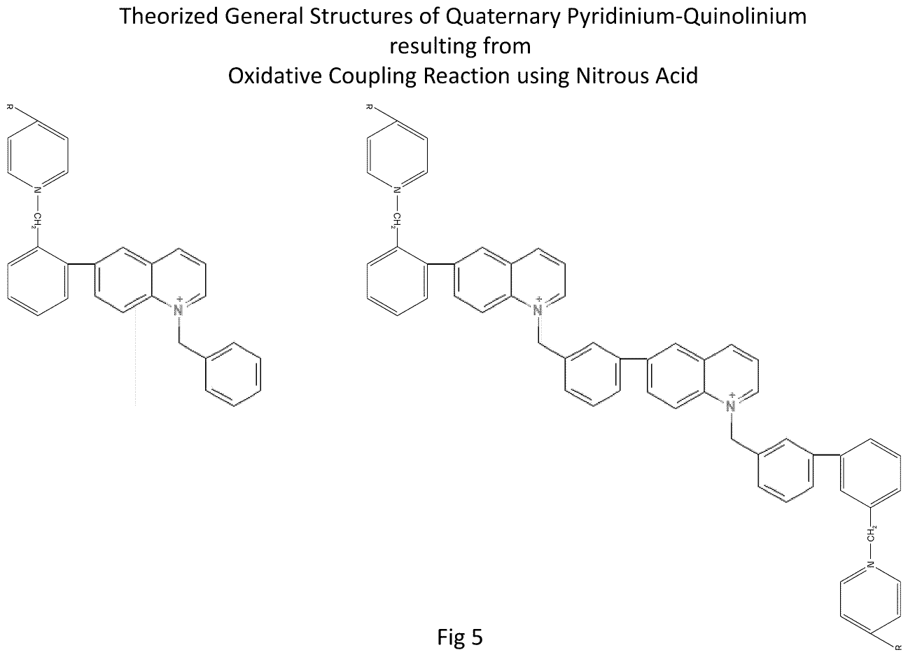

Once thoroughly mixed, 5 ml of 31.25% HCl was slowly added while mixing. The temperature and pH was recorded after acid addition (25° C. and pH 5.48). Photographs were taken before and after acid addition FIGS. 2-5. The solution before acid addition maintained a tan-brown color. After acid addition and 6 minutes of lapsed time, images illustrate the transition to a red-black color which continued to darken for about 75 min. After about 75 min the sample appeared black with no visible change in color after this period of lapsed time. Sample labeled SYN #2.

### Example 3

Quaternary Pyridinium-Pyridinium Complex.

A 500 ml round bottom reactor with magnetic stirring rod was secured on top of a magnetic stirrer. The following was added to the reactor while stirring:
100 ml Denatured Alcohol
100 ml R.O. Water
18.2 g KNO₂
20 ml Uniquat 10-80 (supplied by Arxada)

Once thoroughly mixed, increments of 31.25% HCl was slowly added while mixing and monitoring the pH.
5 ml of 31.25% HCl, pH 5.48
5 ml of 31.25% HCl, pH 5.15

5 ml of 31.25% HCl, pH 4.96-Bubbling detected indicating probable NO gas from decomposition of nitrous acid.
5 ml of 31.25% HCl, pH 4.11
2 ml of 31.25% HCl, pH 1.80

After the final addition of acid, the sample rapidly turn dark.

Total concentration of HCl added was about equivalent to a 1:1 molar ratio to the KNO₂ added. Sample labeled as SYN #3.

### Example 4

Quaternary Quinolinium-Quinolinium Complex.

A 500 ml round bottom reactor with magnetic stirring rod was secured on top of a magnetic stirrer. The following was added to the reactor while stirring:
100 ml Denatured Alcohol
100 ml R.O. Water
18.4 g KNO₂
25 ml Alpha 1038 (supplied by Lubrizol)

Once thoroughly mixed, increments of 31.25% HCl was slowly added while mixing and monitoring the pH.
No acid, pH 5.65
5 ml of 31.25% HCl, pH 5.25
5 ml of 31.25% HCl, pH 5.06
5 ml of 31.25% HCl, pH 4.86-Bubbling detected indicating probable nitric oxide (NO) gas from decomposition of nitrous acid.
5 ml of 31.25% HCl, pH 3.92
1 ml of 31.25% HCl, pH 2.20-temperature recorded at 30° C.

At completion of the acid addition, the sample was near black in appearance. The sample was allowed to mix for about 30 minutes, then filtered to remove solids. Sample labeled as SYN #4.

### Example 5

Quaternary Quinolinium-Pyridinium Complex.

A 500 ml round bottom reactor with magnetic stirring rod was secured on top of a magnetic stirrer. The following was added to the reactor while stirring:
100 ml Denatured Alcohol
100 ml R.O. Water
18.15 g KNO₂
10 ml Uniquat 10-80 (supplied by Arxada)
12.5 ml Alpha 1038 (supplied by Lubrizol)

Once thoroughly mixed, increments of 31.25% HCl was slowly added while mixing and monitoring the pH.
No acid, pH 5.70
15 ml of 31.25% HCl, pH 4.80 Gas liberation (boiling effect throughout sample). Rapid darkening in color.
5 ml of 31.25% HCl, pH 4.30
1 ml of 31.25% HCl, pH 2.90

At completion of the acid addition, the sample was near black in appearance. The sample was allowed to mix for about 30 minutes, then filtered to remove solids. Sample labeled as SYN #5.

### Example 6

Quaternary Quinolinium-Quinolinium Complex.

A 100 ml round bottom reactor with magnetic stirring rod was secured on top of a magnetic stirrer. The following was added to the reactor while stirring:
20 ml Denatured Alcohol
100 μl HCl (31.25%)
10 ml Alpha 1038 (supplied by Lubrizol)

A nitrite donor solution was prepared by dissolving 1.15 g potassium nitrite in 8.85 ml R.O. water. While mixing the reactor solution, the nitrite donor solution was slowly added into the vortex using a slow drip over about 5 minutes. After about 10 minutes of mixing, the pH of the reacting solution was measured and recorded 4.75. The solution was allowed to mix for another 3 hours. After several hours of resting, a very small amount of sediment was observed in the bottom of the reactor. The sample was labeled SYN #6.

### Example 7

Quaternary Quinolinium-Quinolinium Complex.

A 100 ml round bottom reactor with magnetic stirring rod was secured on top of a magnetic stirrer. The following was added to the reactor while stirring:
20 ml ethylene glycol monobutylether
100 μl HCl (31.25%)
10 ml Alpha 1038 (supplied by Lubrizol)

A nitrite donor solution was prepared by dissolving 1.15 g potassium nitrite in 8.85 ml R.O. water. While mixing the reactor solution, the nitrite donor solution was slowly added into the vortex using a slow drip over about 5 minutes. The solution was allowed to mix for another 1 hour. No precipitate was observed in the bottom of the reactor. The sample was labeled SYN #7.

### Example 8

Quaternary Pyridinium-Quinolinium Complex.

A 100 ml round bottom reactor with magnetic stirring rod was secured on top of a magnetic stirrer. The following was added to the reactor while stirring:

20 ml ethylene glycol monobutylether
100 μl HCl (31.25%)
5 ml Alpha 1038 (supplied by Lubrizol)
5 ml Uniquat 10-80 (supplied by Arxada)

A nitrite donor solution was prepared by dissolving 1.15 g potassium nitrite in 8.85 ml R.O. water. While mixing the reactor solution, the nitrite donor solution was slowly added into the vortex using a slow drip over about 5 minutes. The solution was allowed to mix for another 1 hour. No precipitate was observed in the bottom of the reactor. The sample was labeled SYN #8.

### Example 9

Quaternary Quinolinium-Quinolinium Complex.

A 100 ml round bottom reactor with magnetic stirring rod was secured on top of a magnetic stirrer. The following was added to the reactor while stirring:
20 ml ethylene glycol monobutyl ether
10 ml Alpha 1038 (supplied by Lubrizol)

A nitrite donor solution was prepared by dissolving 6.88 g potassium nitrite in 6 ml R.O. water. The nitrite donor solution was added into the vortex. 8.1 ml of HCl (31.25% Active) was slowly added while mixing. The pH after the acid addition was 3.92. The solution was allowed to mix for about 2 hours. The dark red-black solution was decanted leaving behind precipitated solids. The solids where triple rinsed with acetone revealing crystalline salts that readily dissolved in water. The sample was labeled SYN #9.

### Example 10

Quaternary Pyridinium-Quinolinium Complex.

A 100 ml round bottom reactor with magnetic stirring rod was secured on top of a magnetic stirrer. The following was added to the reactor while stirring:
20 ml ethylene glycol monobutyl ether.
6.77 g potassium nitrite was added followed by 6 ml R.O. water and mixed until dissolved.
5 ml Alpha 1038 (supplied by Lubrizol)
5 ml Uniquat 10-80 (supplied by Arxada)

While monitoring pH 31.25% HCl was added in 1 ml increments until the pH was <4.0 which required about 9 ml acid. The solution was allowed to mix for about 1 hour. The dark red-black solution was decanted leaving behind precipitated solids. The solids where triple rinsed with acetone revealing crystalline salts that readily dissolved in water. The sample was labeled SYN #10.

### Example 11

A 100 ml round bottom reactor with magnetic stirring rod was secured on top of a magnetic stirrer. The following was added to the reactor while stirring:
20 ml ethylene glycol monobutyl ether,
6.80 g potassium nitrite was added followed by 4.5 ml R.O. water and mixed until dissolved, and
10 ml Alpha 1038 (supplied by Lubrizol).

While monitoring pH 1 ml formic acid (90%) was added in 100 μl increments. The pH was ~4.7. The solution was allowed to mix for about 4 hours. Upon completion, the sample was allowed to rest for about 30 min allowing separation of the dark red-black solution from a water phase. The OCP was decanted leaving behind the water phase. The sample was labeled SYN #11.

### Example 12

A 100 ml round bottom reactor with magnetic stirring rod was secured on top of a magnetic stirrer. The following was added to the reactor while stirring:
20 ml ethylene glycol monobutyl ether,
1 ml of 90% Formic acid, and
10 ml Alpha 1038 (supplied by Lubrizol).

6.8 g potassium nitrite was dissolved in 30 ml of R.O. water and mixed until dissolved. The potassium nitrite solution was slowly dripped into the vortex of the mixing reactor solution over a period of about 11 minutes. The solution was allowed to vigorously mix for about 3 hours.

The resulting OCP was allowed to rest for about 15 minutes after which there were two distinct phases. The OCP product was slowly decanted to separate the OCP product from the water phase. The sample was labeled 3 mol SYN Alpha.

### Example 13

A 100 ml round bottom reactor with magnetic stirring rod was secured on top of a magnetic stirrer. The following was added to the reactor while stirring:
20 ml ethylene glycol monobutyl ether,
8 ml of 31.25 wt % HCl, and
10 ml Alpha 1038 (supplied by Lubrizol).

6.8 g potassium nitrite was dissolved in 30 ml of R.O. water and mixed until dissolved. The potassium nitrite solution was slowly dripped into the vortex of the mixing reactor solution over a period of about 30 minutes. The solution was allowed to vigorously mix for about 3 hours.

The resulting composition was decanted into a separating funnel and allowed to separate for approximately 30 minutes. The water phase was drained from the OCP product phase. The sample was labeled “SYN Alpha 7” for the estimated average oligomer units.

### Coupon Testing

Coupons for screening purposes were comprised of 1010 carbon steel. Coupons comprising 1010 carbon steel are far more susceptible to acid corrosion compared to alloys like N80.

Acidizing samples were prepared using 15 wt % HCl and treated with the appropriate corrosion inhibitors and intensifiers as disclosed resulting in beakers containing approximately 190 ml of acidizing solution. The samples were placed in a water bath, the water coated with a layer of silicone oil to retain heat. A thermometer in a sealed water filled jar was used to monitor the liquid temperature in the samples. A digital heater was set at 300° C. to begin heating the samples. Once the sample temperatures reached 90° C., the heater was reduced to 200° C. which sustained 94-95° C. consistently throughout the duration of the test. The test duration of 4 hours began when the sample temperature exceeded 90° C.

TABLE 1

| SYN #9 (1980 ppm as | | |
|---|---|---|
| active Alpha 1038) | 2.4 ml | 2.4 ml |
| KI | 0.65 ml KI Soln | 0.65 ml KI Soln |
| Formaldehyde | 0.55 ml (37%) | NA |
| Glyoxal | NA | 0.55 ml (40%) |
| Starting Wt | 12.31 g | 12.28 g |
| Final Wt | 12.17 g | 12.00 g |
| % loss | 1.14% | 2.28% |
| Blend Alpha 1038 + | | |
| Uniquat 10-80 (10 gpt) | 0.95 ml + 0.95 ml | 0.95 ml + 0.95 ml |
| KI | 0.65 ml KI Soln | 0.65 ml KI Soln |
| Formaldehyde | 0.55 ml (37%) | NA |
| Glyoxal | NA | 0.55 ml (40%) |
| Starting Wt | 12.16 g | 12.32 g |
| Final Wt | 12.09 g | 12.18 g |
| % loss | 0.58% | 1.15% |
| Alpha 1038 (10 gpt) | 1.9 ml | 1.9 ml |
| KI | 0.65 ml KI Soln | 0.65 ml KI Soln |
| Formaldehyde | 0.55 ml (37%) | NA |
| Glyoxal | NA | 0.55 ml (40%) |
| Starting Wt | 12.34 | 12.25 |
| Final Wt | 12.23 | 12.07 |
| % loss | 0.89% | 1.47% |

SYN #9 at 1980 ppm as active Alpha 1038 performed surprisingly well with only 20% of the quaternary aromatic corrosion inhibitor compared to the blend of Alpha 1038+Uniquat 10-80 and the stand alone Alpha 1038 that was used to produce the OCP of SYN #9.

In the next series of test, equivalent comparative samples were prepared comprising the Blend of Alpha 1038 and Uniquat 10-80 and Alpha 1038 alone. However, the SYN #9 dosage was increased to 3960 ppm based on the calculated active Alpha 1038.

TABLE 2

| SYN #9 (3960 ppm as | | |
|---|---|---|
| active Alpha 1038) | 4.8 ml | 4.8 ml |
| KI | 0.65 ml KI Soln | 0.65 ml KI Soln |
| Formaldehyde | 0.55 ml (37%) | 0.55 ml (40%) |
| Starting Wt | 12.19 g | 12.34 g |
| Final Wt | 12.16 g | 12.32 g |
| % loss | 0.25% | 0.16% |

| Blend Alpha 1038 + | |
|---|---|
| Uniquat 10-80 (10 gpt) | 0.95 ml + 0.95 ml |
| KI | 0.65 ml KI Soln |
| Formaldehyde | 0.55 ml (37%) |
| Starting Wt | 12.33 g |
| Final Wt | 12.25 g |
| % loss | 0.65% |
| Alpha 1038 (10 gpt) | 1.9 ml |
| KI | 0.65 ml KI Soln |
| Formaldehyde | 0.55 ml (37%) |
| Starting Wt | 12.28 g |
| Final Wt | 12.17 g |
| % loss | 0.90% |

The metal loss results illustrate exceptional corrosion inhibition provided by the SYN #9 sample comprising quaternary quinolinium-quinolinium complex using only 40% of the actives compared to the commercially available quaternary aromatic corrosion inhibitors.

The testing methods were repeated using formic acid and potassium iodide intensifiers with SYN #9 and SYN #10 comprising quaternary pyridinium-quinolinium OCP.

TABLE 3

| SYN #9 | 2.4 ml | 2 ml |
|---|---|---|
| KI | 0.65 ml KI Soln | 0.65 ml KI Soln |
| Formic Acid | 0.4 ml (90%) | 0.4 ml (90%) |
| Start Weight | 12.28 | 12.35 |
| Final Weight | 12.17 | 12.33 |
| wt % loss | 0.89% | 0.16% |
| SYN #10 | 2.4 ml | 2 ml |
| KI | 0.65 ml KI Soln | 0.65 ml KI Soln |
| Formic Acid | 0.4 ml (90%) | 0.4 ml (90%) |
| Start Weight | 12.23 | 12.32 |
| Final Weight | 12.14 | 12.3 |
| wt % loss | 0.74% | 0.16% |

The data clearly illustrates the oxidative coupling product resulting from nitrous acid initiated oxidative coupling reaction provides superior corrosion inhibition when compared to the quaternary aromatic corrosion inhibitors used to produce the OCP.

Synthetic acid was produced by combining glycine, water and hydrochloric acid to produce a 15 wt % HCl solution having glycine at a molar ratio of 1:2 glycine: HCl respectively. SYN #11 was used along with various intensifiers selected from glyoxal and potassium iodide. Samples were run at 98° C. for 4.5 hrs using a water bather with a silicone oil film to suppress evaporation.

TABLE 4

| 1:2 GN:HCI | 185 ml | 185 ml | 92.5ml (7,5% HC) | 185 ml | 185 ml |
|---|---|---|---|---|---|
| SYN #11 | 4.8 ml | 4.8 ml | 2.4 ml | 4.8 ml | 2.4 ml |
| | 0.65 ml KI Soln | 0,65 ml Kl Soln | 0.65 ml Kl | 0.65 ml Kl Soln | 0.65 ml Ki Soln |
| Glyoxal | 0.27 ml (40%) | 0.81 ml (40%) | NA | NA | NA |
| | | 92.5 ml H₂O | | | |
| Start Wt (g) | 12.37 | 12.28 | 12.35 | 12.34 | 12.23 |
| Finish Wt (g) | 12.31 | 12.21 | 12.30 | 12:27 | 12.17 |
| Difference (g) | 0.06 | 0.07 | 0.05 | 0.07 | 0.06 |
| % loss | 048% | 0.57% | 0.40% | 0.57% | 0.49% |

The results of these test illustrate a low concentration (<2000 ppm) of SYN 11 OCP comprising quaternary quinolinium-quinolinium complex worked as well as the sample having 2× the concentration of OCP.

| H₂O | 122 ml |
|---|---|
| HCI | 62 ml |
| 3 mol SYN Alpha | 4.8 ml |
| Glyoxal | 1 ml (2100 ppm) |
| H₂O₂ | NA |
| Start Weight | 12.32 |
| Final Weight | 12.25 |
| Delta Wt | 0.07 |
| % loss | 0.57% |

The result of this test illustrates 3 mol SYN Alpha using glyoxal as an intensifier performed as well as treatments using synthetic acid comprising a 1:2 molar ratio of glycine:HCl respectively. This is a surprising result and a significant benefit as a result of substantially reducing the cost of producing the acidizing treatment.

SYN Alpha 7 was tested to assess the effect anionic surfactants have on the corrosion inhibition of 1010 carbon steel corrosion coupons at >200° F. for 4 hours.

| | IL | 2L |
|---|---|---|
| Stock 15% HCI | 183 ml | 183 ml |
| SYN Alpha 7 | 4.8 ml (6000 ppm) | 4.8 ml (6000ppm) |
| KI | 0.65 ml | 0.65 ml |
| Cal-Fax (20% as Active) | 0.6 ml | Na |
| Stepan 8182 | NA | 0.6 ml |
| (20% as Active) | | |
| Start Weight | 12.32 g | 12.35 g |
| Final Weight | 12.26 g | 12.26 g |
| wt loss | 0.06 g | 0.09 g |
| % wt loss | 0.49 | 0.73 |

### Limestone Digestion

Samples of various acidizing compositions were heated in a water bath to 65° C. (150° F.). Sample volumes were 190 ml. Indiana limestone samples were obtained and cut from a slab to obtain samples of approximately the same geometry and weight. A Nalgene sample bottle containing the heated sample to be tested was weighed then zeroed. The pre-weighed limestone sample was dropped into the heated sample and time was monitored while recording the remaining weight of the limestone sample in 1-minute increments. The accumulated weight loss was plotted to compare the trajectory of the slopes over time.

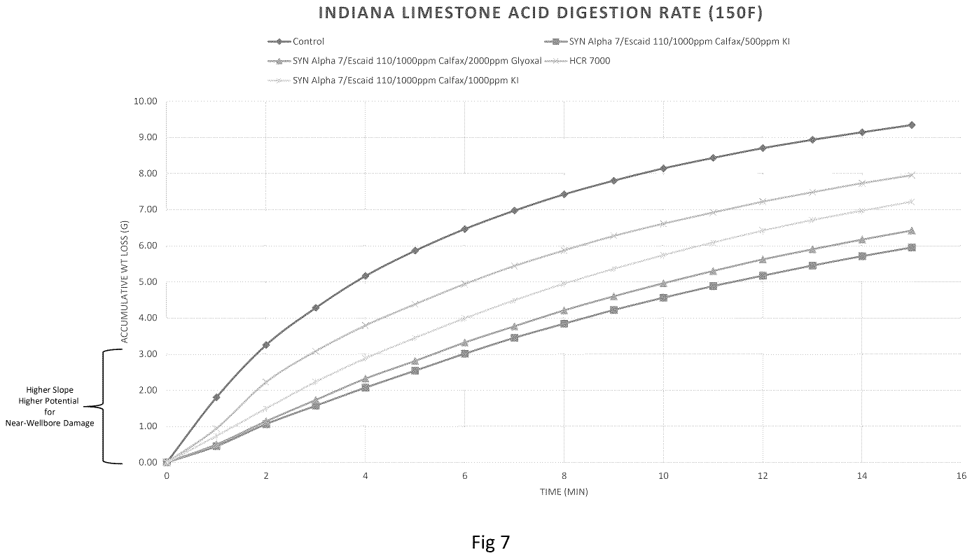

FIG. 7 provides a comparison between preferred compositions of the present invention to that of a Control comprising 15 wt % HCl and a commercially available acidizing composition HCR 7000 as illustrated in U.S. Pat. No. 10,822,535.

The graphs illustrate the compositions of the present invention effectively retard the rate of digestion of the limestone without the use of amine based retarding agents as disclosed in the prior art. Furthermore, the rate of digestion resulting from the preferred compositions results in a near linear slope, providing a very predictable digestion rate thereby providing dramatic increases in acid efficiency while reducing the potential for formation damage near the wellbore.

These improvements allow for the point-of-use dilution while providing results comparable to using full strength 15% HCl. This in-turn reducing transportation, storage, cost of acid and cost associated with adding 1:4 molar ratios of amine exemplified by monoethanolamine.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

1. A composition for acidizing a wellbore, the composition comprising:
at least one mineral acid, an effective amount of oxidative coupling product, a surfactant and at least one intensifier;
the mineral acid comprises at least hydrochloric acid in an amount ranging from about 10 to 20 wt % HCl, and
wherein the oxidative coupling product comprises at least one of an oligomer and co-oligomer resulting from an oxidative coupling reaction between at least one of a quaternary quinolinium and a quaternary pyridinium.

2. The composition in accordance with claim 1, wherein the hydrochloric acid comprises about 15 wt % HCl.

3. The composition in accordance with claim 1, wherein the intensifier comprises an iodide donor.

4. The composition in accordance with claim 1, wherein the oxidative coupling product ranges from about 1000 to 10000 ppm as active oxidative coupling product.

5. The composition in accordance with claim 1, wherein the composition is diluted with water at the point-of-use to achieve a ratio of composition and water of 1:1 respectively.

6. The composition in accordance with claim 1, wherein the composition is diluted with water at the point-of-use to achieve a ratio of composition and water of 1:2 respectively.

7. The composition in accordance with claim 1, wherein the surfactant comprises a nonionic surfactant.

8. The composition in accordance with claim 1, wherein the surfactant comprises an anionic surfactant.

9. The composition in accordance with claim 8, wherein the anionic surfactant is selected from at least one of an alkylether sulfates, alkyl sulfates, alkyl sulfonates, alkyl benzene sulfonates, alkyldiphenyloxide disulfonate and phosphate ester.

10. The composition in accordance with claim 1, wherein the intensifier comprises at least one of a formaldehyde, acetaldehyde, formic acid, antimony, stannous, bismuth, germanium and dialdehyde.

11. The composition in accordance with claim 10, wherein the dialdehyde comprises glyoxal.

12. The method in accordance with claim 1, wherein the oxidative coupling product is the result of:
combining and mixing in a vessel a solvent, at least one quaternary aromatic corrosion inhibitor selected from at least one of a quaternary pyridinium and a quaternary quinolinium, a nitrite donor and an acid;
the solvent comprises at least one of a glycol ether, an alcohol and water;
the nitrite donor in an amount to provide greater than or equal to 0.2 mole of nitrite per mole of quaternary aromatic corrosion inhibitor;
the acid in an amount sufficient to in-situ generate an effective amount of nitrous acid;
the nitrous acid initiates an oxidative coupling reaction producing the oxidative coupling product, and
wherein the oxidative coupling product comprises two or more carbon-carbon bonded quaternary aromatic corrosion inhibitors.

13. The composition in accordance with claim 1, further comprising a quaternary aromatic phosphonium selected from at least one of benzyltriphenylphosphonium salts and tetraphenylphosphonium salts.

14. The composition in accordance with claim 1, further comprising an effective amount of aliphatic oil.

15. A method of forming a hydrocarbon-bearing formation for a stimulation operation, the method comprising the steps:
providing a wellbore having a casing;
assessing at least a first location and a second location for perforation of the casing;
inserting a bottom hole assembly into the well-bore; the bottom hole assembly comprising a plug and a perforation tool and the bottom hole assembly being connected to a wireline;
injecting an acidic composition into the wellbore;
wherein the acidic composition is in direct contact with the perforation tool, the wireline and the casing;
positioning and setting the plug in the wellbore at a position downhole but proximate to the first location;
positioning the perforation tool at the first location;
perforating the casing at the first location with the perforation tool thereby creating a first perforated area and a first cementitious debris;
allowing the acidic composition to come into contact with the first perforated area and the first cementitious debris for a predetermined period of time to prepare the formation for the stimulation operation;
moving the perforation tool up-hole to the second location;
perforating the casing at the second location with the perforation tool thereby creating a second perforated area and a second cementitious debris;
allowing the acidic composition to come into contact with the second perforated area and the second cementitious debris for a predetermined period of time to prepare the formation for the stimulation operation;
removing the perforation tool from the wellbore;
wherein the acid composition comprises an acid and a corrosion inhibitor composition, the corrosion inhibitor composition comprising:
an effective amount of corrosion inhibiting oxidative coupling product, at least one anionic surfactant and at least one intensifier;
the oxidative coupling product comprises at least one of an oligomer and co-oligomer resulting from an oxidative coupling reaction between at least one of quaternary quinolinium and quaternary pyridinium; and
wherein the intensifier comprising at least one of an iodide donor and dialdehyde.

16. The corrosion inhibiting composition in accordance with claim 15, wherein the oxidative coupling product ranges from about 1000 to 10000 ppm as active oxidative coupling product.

17. The corrosion inhibiting composition in accordance with claim 15, wherein the oxidative coupling product ranges from about 1000 to 10000 ppm as active oxidative coupling product.

18. The composition in accordance with claim 15, wherein the dialdehyde comprises glyoxal.

19. The acid composition in accordance with claim 15, wherein the composition is diluted with water at the point-of-use to achieve a ratio of composition and water of 1:1 respectively.

20. The acid composition in accordance with claim 15, wherein the composition is diluted with water at the point-of-use to achieve a ratio of composition and water of 1:2 respectively.

21. The corrosion inhibiting composition in accordance with claim 15, wherein the anionic surfactant comprising at least one of an alkyl ether sulfates, alkyl sulfates, alkyl sulfonates, alkyl benzene sulfonates, alkyldiphenyloxide disulfonate and phosphate ester.

22. The method in accordance with claim 15, wherein the oxidative coupling product is the result of:
combining and mixing in a vessel a solvent, at least one quaternary aromatic corrosion inhibitor selected from at least one of a quaternary pyridinium and a quaternary quinolinium, a nitrite donor and an acid;
the solvent comprises at least one of a glycol ether, an alcohol and water;
the nitrite donor in an amount to provide greater than or equal to 0.2 mole of nitrite per mole of quaternary aromatic corrosion inhibitor;
the acid in an amount sufficient to in-situ generate an effective amount of nitrous acid;
the nitrous acid initiates an oxidative coupling reaction producing the oxidative coupling product, and
wherein the oxidative coupling product comprises two or more carbon-carbon bonded quaternary aromatic corrosion inhibitors.
